(19) United States
(12) Patent Application Publication
(10) Pub. No.: US 2024/0324759 A1
(43) Pub. Date: Oct. 3, 2024

(54) Oral Care Implement Kit

(71) Applicant: Colgate-Palmolive Company, New York, NY (US)

(72) Inventors: Joppe Gideon VAN DIJK, Rotterdam (NL); Tim Anton SNIJDER, Rotterdam (NL); Thomas VAN DE WATER, Den Haag (NL); Salvador Emilio LLUCH SICARD, Den Haag (NL)

(73) Assignee: Colgate-Palmolive Company, New York, NY (US)

(21) Appl. No.: 18/615,273

(22) Filed: Mar. 25, 2024

Related U.S. Application Data
(60) Provisional application No. 63/492,542, filed on Mar. 28, 2023.

(51) Int. Cl. A46B 5/00; A46B 15/00

(52) U.S. Cl. CPC A46B 5/0095; A46B 15/0046; A46B 2200/1066

(57) ABSTRACT

An oral care implement kit which incorporates a handle, a first head, and a second head. The handle has a vibration generation device, a processor, a memory, and a sensor. The first head and second head are configured to be detachably coupled to the handle. The processor is operably coupled to the vibration generation device and the sensor. The sensor is configured to sense which of the first and second heads is coupled to the handle.

### CROSS-REFERENCE TO RELATED APPLICATIONS

The present application claims priority to U.S. Provisional Patent Application Ser. No. 63/492,542, filed Mar. 28, 2023, the entirety of which is incorporated herein by reference.

### BACKGROUND

Oral care, particularly care of an individual's teeth and gums, are of utmost importance to ensure overall health. However, typical oral care routines are time consuming. For instance, most dentists recommend brushing teeth for a minimum of two minutes. Those individuals who may have dexterity problems or may not wish to spend the required time brushing may suffer from poor oral health. Thus, a need exists for oral care implements which remedy the deficiencies in existing products.

### BRIEF SUMMARY

The present invention is directed to an oral care implement having a handle and a head detachably coupled to the handle. The head has a neck portion and a head portion coupled to the neck portion. The head portion has a base structure, a sheet structure, and a guard structure. The sheet structure is in contact with the base structure and has a front surface, a rear surface, and a plurality of bristle tufts extending from the front surface of the sheet structure. The guard structure has a front surface and a rear surface. The front surface of the guard structure is joined to at least a portion of the rear surface of the sheet structure to encapsulate the base structure between the sheet structure and the guard structure.

In one aspect, the invention may be an oral care implement kit having a handle, a first head configured for detachable coupling to the handle, and a second head configured for detachable coupling to the handle. The handle has a vibration generation device, a processor operably coupled to the vibration generation device, a memory operably coupled to the processor, and a sensor operably coupled to the processor. The sensor is configured to sense which of the first and second heads is coupled to the handle.

In another aspect, the invention may be an oral care implement kit having a handle and a head configured for detachable coupling to the handle. The handle has a vibration generation device, a processor operably coupled to the vibration generation device, a memory operably coupled to the processor, and a sensor operably coupled to the processor. The sensor is configured to sense a characteristic of the head and alter an operating parameter of the vibration generation device using the characteristic indicative of inertia.

In a further aspect, the invention may be a method of operating an oral care implement. In step a), a handle is provided, the handle having a vibration generation device, a processor operably coupled to the vibration generation device, a memory operably coupled to the processor, and a sensor operably coupled to the processor. In step b), a head is coupled to the handle. In step c), a brushing routine is initiated, the brushing routine involving causing the vibration generation device to emit vibrations. In step d) the sensor senses a characteristic of the head. Finally, in step e), an operating parameter of the vibration generation device is altered based on the characteristic sensed by the sensor.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of an oral care implement kit in accordance with an embodiment of the present invention;

FIG. 2A is a perspective view of an oral care system incorporating the oral care implement kit of FIG. 1;

FIG. 2B is a partial sectional view of an oral care implement of the oral care implement kit of FIG. 1;

FIG. 2C schematically illustrates the components of the oral care implement of the oral care kit of FIG. 1;

FIG. 2D schematically illustrates electronic components of a data processing unit shown in FIG. 2A; and

FIG. 3 is flowchart showing a method of operating the oral care implement of the oral care kit of FIG. 1.

### DETAILED DESCRIPTION

The following description of the preferred embodiment(s) is merely exemplary in nature and is in no way intended to limit the invention, its application, or uses.

The description of illustrative embodiments of principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

Features of the present invention may be implemented in software, hardware, firmware, or combinations thereof. The programmable processes described herein are not limited to any particular embodiment, and may be implemented in an operating system, application program, foreground or background processes, driver, or any combination thereof. The computer programmable processes may be executed on a single processor or on or across multiple processors.

Processors described herein may be any central processing unit (CPU), microprocessor, micro-controller, computational, or programmable device or circuit configured for executing computer program instructions (e.g., code). As used herein, the terms “processor” and “programmable processor” are used interchangeably. Various processors may be embodied in computer and/or server hardware of any suitable type (e.g. desktop, laptop, notebook, tablets, cellular phones, etc.) and may include all the usual ancillary components necessary to form a functional data processing device including without limitation a bus, software and data storage such as volatile and non-volatile memory, input/output devices, graphical user interfaces (GUIs), removable data storage, and wired and/or wireless communication interface devices including Wi-Fi, Bluetooth, LAN, etc.

Computer-executable instructions or programs (e.g., software or code) and data described herein may be programmed into and tangibly embodied in a non-transitory computer-readable medium that is accessible to and retrievable by a respective processor as described herein which configures and directs the processor to perform the desired functions and processes by executing the instructions encoded in the medium. A device embodying a programmable processor configured to such non-transitory computer-executable instructions or programs is referred to hereinafter as a “programmable device”, or just a “device” for short, and multiple programmable devices in mutual communication is referred to as a “programmable system”. It should be noted that non-transitory “computer-readable medium” as described herein may include, without limitation, any suitable volatile or non-volatile memory including random access memory (RAM) and various types thereof, read-only memory (ROM) and various types thereof, USB flash memory, and magnetic or optical data storage devices (e.g. internal/external hard disks, floppy discs, magnetic tape CD-ROM, DVD-ROM, optical disk, ZIP™ drive, Blu-ray disk, and others), which may be written to and/or read by a processor operably connected to the medium.

In certain embodiments, the present invention may be embodied in the form of computer-implemented processes and apparatuses such as processor-based data processing and communication systems or computer systems for practicing those processes. The present invention may also be embodied in the form of software or computer program code embodied in a non-transitory computer-readable storage medium, which when loaded into and executed by the data processing and communications systems or computer systems, the computer program code segments configure the processor to create specific logic circuits configured for implementing the processes.

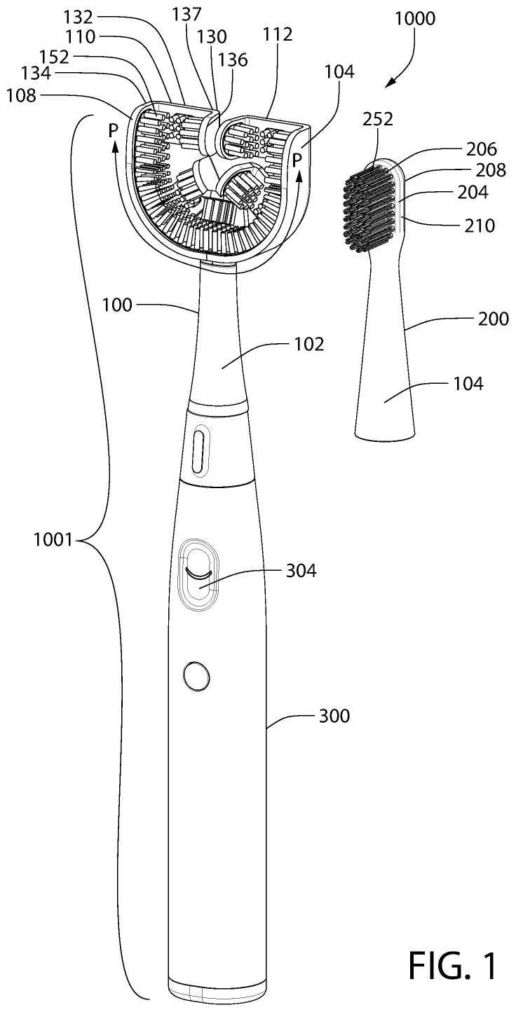

Referring to FIG. 1, an oral care implement kit 1000 is illustrated in accordance with an embodiment of the present invention. The oral care implement kit 1000 comprises a first head 100, a second head 200, and a handle 300. The handle 300 and one of the first or second heads 100, 200 collectively form an oral care implement 1001. The oral care implement 1001 may be a powered device for cleaning a user's teeth and other oral tissues. The first and second heads 100, 200 are configured for detachable coupling to the handle 300 to allow replacement of the first and second heads 100, 200. Each of the first and second heads 100, 200 engages a stem of the handle 300 or other engagement feature to enable detachable coupling of the first and second heads 100, 200 to the handle 300 during a brushing routine.

Each of the first and second heads 100, 200 has a neck portion 102, 202 and a head portion 104, 204. The head portion 104 is coupled to the neck portion 102 and has a generally arcuate shape suitable for insertion into a user's oral cavity. The head portion 104 is configured to engage a plurality of the user's teeth simultaneously. The head portion 104 extends along a path P-P. Optionally, the path P-P may be an arcuate path. The path P-P may be selected to correspond to a user's dental arch. Optionally, the path P-P may be a continuous arc or may be formed of a series of linear segments or arcs, or a combination of arcs and linear segments. Furthermore, the path P-P may be any shape forming a generally concave path and may incorporate any curved geometry.

The head portion 104 further has a wall 108, the wall 108 extending along the path P-P from a first distal end 110 to a second distal end 112. The wall 108 has a generally concave shape but need not take the form of a single arc of constant radius. The wall 108 may instead be a composite concave shape comprising a plurality of arcs and line segments, or other geometry that collectively forms a curved shape. A plurality of fingers 130 extend from the wall 108. It is conceived that the head portion 104 may correspond to a user's full dental arch or only a portion of the user's dental arch.

In some implementations, the head portion 104 may be symmetrical and extend along a majority of the user's dental arch. In yet other implementations, the head portion 104 may be asymmetrical such that it extends along less than half of the user's dental arch. In other implementations, the head portion 104 may be configured to cover approximately one half of the user's dental arch. In these implementations, the head portion 104 may engage one side of the user's mouth at a time. The head portion 104 may be moved along the dental arch to brush all teeth of the dental arch. It is further contemplated that the head portion 104 may engage only a single jaw or may engage both upper and lower jaws simultaneously. Where the head portion 104 engages both upper and lower jaws, the fingers 130 may extend in opposite directions to engage different jaws or components of the head portion 104 may be duplicated to allow simultaneous brushing of both top and bottom jaws.

The plurality of fingers 130 each has a horizontal portion 132 extending from the wall 108. The plurality of fingers 130 also has a first bend 134, a tip portion 136, and a second bend 137. The tip portion 136 extends from the horizontal portion 132 at the second bend 137. The first bend 134 is located at the transition between the horizontal portion 132 and the wall 108. In the present embodiment there are five fingers 130, but in other embodiments there may be greater or fewer than five fingers 130. As can be seen, the fingers 130 are bent to form an L shape. The fingers 130 and the wall 108 generally form a U shape in cross-section. In other implementations, the tip portions 136 of the fingers 130 may extend in opposite directions to enable simultaneous brushing of both top and bottom jaws. In yet other embodiments, the fingers 130 need not all have their horizontal portions 132 lying along a plane. In these embodiments, the horizontal portions 132 may be angled with respect to one another, parallel but non-planar with respect to one another, or even have a radius of curvature which is greater than a radius of curvature of either of the first and second bends 134, 137.

Each of the fingers 130 is spaced and isolated from the other fingers 130, although in some embodiments the fingers 130 may be in surface contact. Preferably, the fingers 130 are not coupled to one another, but are exclusively coupled to the wall 108. An arcuate channel is formed between the fingers 130 and the wall 108. This arcuate channel effectively surrounds the user's teeth, ensuring brushing on three sides of each tooth simultaneously. Combined with movement along the user's dental arch, all surfaces of all teeth can be reached. The arcuate channel may have a U shape in cross-section but need not be symmetrical.

As can be seen, the head portion 104 has a plurality of tooth cleaning elements 152, the plurality of tooth cleaning elements 152 extending from the wall 108 and the plurality of fingers 130. The fingers 130 have tooth cleaning elements 152 on both the horizontal portion 132 and the tip portion 136. The tooth cleaning elements 152 are formed of filament bristles, and may be formed of any known bristle filament material. Such materials may include Polybutylene Terephthalate (“PBT”), nylon, polypropylene, or other natural or synthetic materials. The tooth cleaning elements 152 may be molded cleaning elements or conventional filament bristles. The tooth cleaning elements 152 may be arranged in a plurality of bristle tufts, one or more blocks of bristle tufts, one or more blocks of molded cleaning elements, or any combination thereof.

The head portion 204 of the second head 200 has a front surface 206, a rear surface 208 opposite the front surface 206, and a peripheral surface 210 extending between the front and rear surfaces 206, 208. A plurality of tooth cleaning elements 252 extend from the front surface 206. The front surface 206 and the rear surface 208 of the head portion 204 can take on a wide variety of shapes and contours, none of which are limiting of the present invention. For example, the front and rear surfaces 206, 208 can be planar, contoured or combinations thereof. In this implementation, the head portion 204 of the second head 200 is configured as a conventional toothbrush refill head. The front surface 206 of the head portion 204 is substantially planar. The tooth cleaning elements 252 may be molded cleaning elements or conventional filament bristles. The tooth cleaning elements 252 may be arranged in a plurality of bristle tufts, one or more blocks of bristle tufts, one or more blocks of molded cleaning elements, or any combination thereof.

In certain embodiments, the head portions 104, 204 may include a single tooth cleaning element 152, 252, and in other embodiments, the head portions 104, 204 may include two or more tooth cleaning elements 152, 252. Common examples of tooth cleaning elements 152, 252 include, without limitation, bristle tufts, filament bristles, fiber bristles, nylon bristles, spiral bristles, rubber bristles, elastomeric protrusions, flexible polymer protrusions, combinations thereof and/or structures containing such materials or combinations. Suitable elastomeric materials include any biocompatible resilient material suitable for uses in an oral hygiene apparatus. To provide optimum comfort as well as cleaning benefits, the tooth cleaning elements 152, 252 may be an elastomeric material having a hardness property in the range of A8 to A25 Shore hardness. Other materials within and outside the noted hardness range may also be used.

The tooth cleaning elements 152, 252 of the present invention can be connected to the head portions 104, 204 in any manner known in the art. For example, staples/anchors, in-mold tufting (IMT) or anchor free tufting (AFT) could be used to mount the tooth cleaning elements 152, 252 of the exemplary embodiment. In AFT, a plate or membrane is secured to the brush head such as by ultrasonic welding. The tooth cleaning elements 152, 252 extend through the plate or membrane. The free ends of the tooth cleaning elements 152, 252 on one side of the plate or membrane perform the cleaning function. The ends of the tooth cleaning elements 152, 252 on the other side of the plate or membrane are melted together by heat to be anchored in place. Alternatively, the tooth cleaning elements 152, 252 may be mounted to tuft blocks or sections by extending through suitable openings in the tuft blocks so that the base of the tooth cleaning elements 152, 252 are mounted within or below the tuft blocks.

The handle 300 has a vibration generation device and a user interface 204 configured to control operation of the vibration generation device. The vibration generation device is preferably a motor, but may be any known type of vibration generation device suitable for transmitting vibrations from the handle 300 to the first or second head 100, 200 to excite the tooth cleaning elements 152, 252 on the first or second head 100, 200. By way of non-limiting example, the vibration generation device may be a motor with an eccentric weight, a piezo-electric device, a motor with driveshaft to power an oscillating element, a pump, or any other device which may generate vibrations. In the case of a pump, it may be a pneumatic or hydraulic pump configured to create a pressure differential in any working fluid including air, water, oil, or any other suitable fluid.

The user interface 204 may be a combination of a switch and a light, exclusively a switch, a button, or any other combination of devices suitable for initiating a brushing routine. Thus, it is conceived that the user interface 204 may include one or more push buttons or switches of any known type. These may be paired with lights, a display device, or a combination of a lights and a display device.

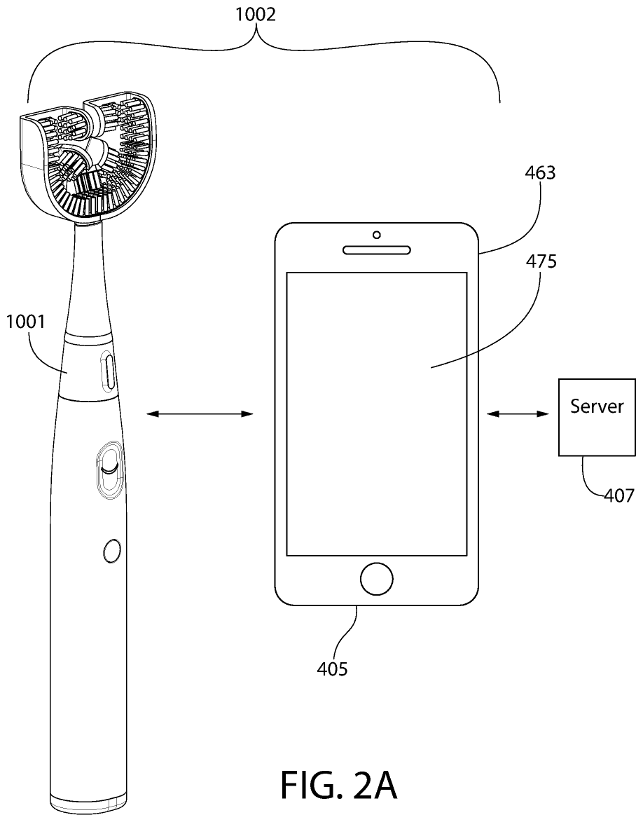

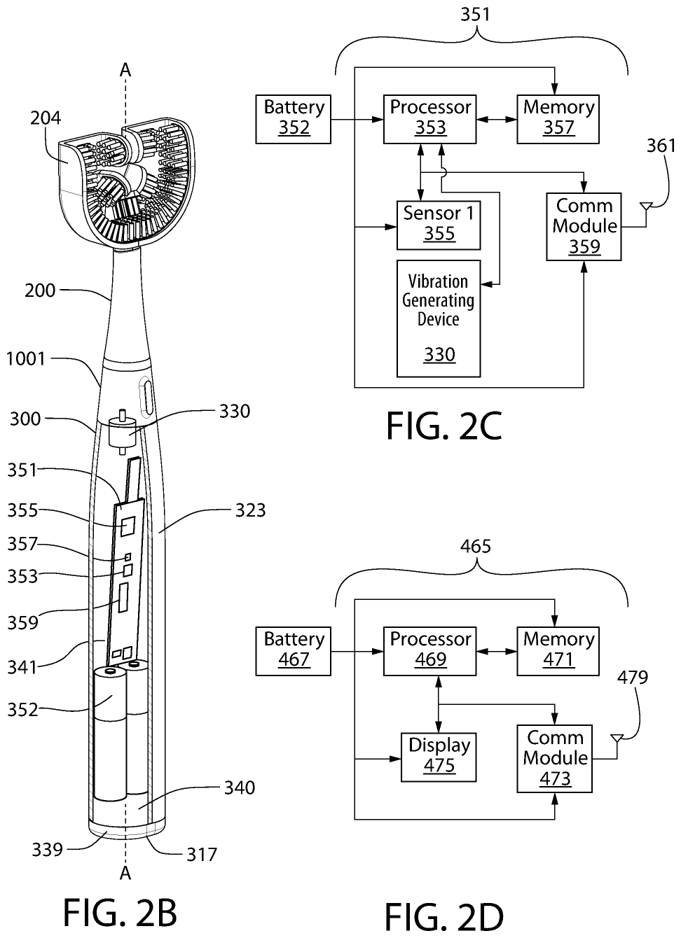

Turning in detail to the drawings, FIG. 2A illustrates an oral care system 1002 in accordance with an embodiment of the present invention. The oral care system 1002 includes the oral care implement 1001 and a data processing unit 405. The data processing unit 405 may communicate with a server 407 for purposes of storing larger amounts of data or to provide server-side processing functionality. The presence of the server 407 and communication between the data processing unit 405 and the server 407, however, are not limiting of the present invention, unless specifically set forth in a claim.

Referring to FIG. 2B, the handle 300 is a housing containing a vibration generation device 330, electronic circuitry 351, and a power source 352. The handle 311 is a hollow structure in which the cavity 341 is formed. More specifically, in the exemplified embodiment, the cavity 341 is formed in an elongated gripping portion 323 of the handle 300. In the exemplary embodiment, the power source 352 is shown as two batteries located within the cavity 341. Of course, the invention is not so limited and more or fewer than two batteries may be used, or alternatively, other types of power sources may be used. A removable end cap 339 may form a proximal end 317 of the handle 300 by engagement with the gripping portion 323 of the handle 300. In the exemplary embodiment, the end cap 339 may threadably engage the gripping portion 323 of the handle 300. In other embodiments, the end cap 339 may engage the gripping portion 323 of the handle 300 by snap engagement or by any other mechanical locking engagement. Removal of the end cap 339 exposes an opening 340 which forms a passageway into the cavity 341 through which the power source 352 can be inserted into and removed from the cavity 341.

Access to the cavity 341 may be formed in other ways in other embodiments. For example, the handle 300 may include a sliding panel which is removable to form an elongated opening along a longitudinal axis A-A of the handle 300 (e.g., the front surface, the rear surface and/or the side surfaces) to provide access to the cavity 341. Prior to use, a user may insert the power source 352 through the opening 340 and into the cavity 341 in the elongated gripping portion 323 of the handle 300, and the cavity 341 is enclosed by replacing the end cap 339.

The vibration generation device 330 may be a motor with eccentric weight, piezo device, a linear device such as a solenoid, or any other suitable device capable of generating vibrations which excite the tooth cleaning elements 152, 252. The vibration generation device 330 is located within the cavity 341 and may be mounted such that it efficiently transmits vibration to a head when the head is coupled to the handle 300. Preferably, the vibration generation device 330 is mounted such that vibrations are isolated from the gripping portion grasped by the user.

The electronic circuitry 351 which may be included in an exemplary oral care implement 1001 is shown in FIG. 2C. The electronic circuitry 351 includes a processor 353 communicably coupled to at least one sensor 355, a memory 357, and a communication module 359. The number of sensors 355 included as part of the electronic circuitry 351 depends upon the types of characteristics to be detected and the functionality of each type of sensor employed. The detected characteristics may include a vibration response of the handle 300, including a vibration frequency or amplitude. This may be measured via a sensor 355 which is configured to detect vibration, acceleration, changes in orientation, or similar aspects. For instance, an accelerometer or gyroscope may be used to measure the frequency response of the handle 300. The accelerometer or gyroscope may be packaged into an inertial measurement unit (“IMU”) or may be individual components. In other implementations, the detected characteristics may be a moment of inertia, vibration transmissibility, mass of the head, density of the head, or any other characteristic that may impact transmission efficiency of vibrations to the tooth cleaning elements 152, 252.

In other implementations, the detected characteristics may be computed or inferred from measurements of operating parameters of the vibration generation device 330. Thus, the detected characteristics may be indicative of inertia of the head. Such operating parameters may include current, amplitude, or frequency of the vibration generation device 330. Thus, the current consumption or the frequency or amplitude of the current consumption may be measured via one or more sensors 355. These sensors 355 may be voltage, current, or frequency sensors. Processors such as those disclosed herein may be used to perform fast-fourier transforms (“FFTs”) or other analyses to infer information such as a moment of inertia of the head coupled to the handle 300. Other information such as the frequency response of the head may analyzed to identify the head which is coupled to the handle 300.

Alternately, the presence or absence of a specific head having known characteristics may be identified by a sensor 355 which is capable of detecting a physical feature of the head, a magnet, or other identifying feature. For instance, a protuberance may be used to activate a switch which serves as the sensor 355. Alternately, a reed switch, hall-effect circuit, variable-reluctance sensor, or other similar device may be used as the sensor 355 to register presence or absence of a magnet or metallic component which identifies a particular head. In yet other configurations, the sensor 355 may read information from a head via an optical means, electromagnetic means, or via electrical connections between the sensor 355 and the head. Examples include an RFID tag, a barcode, a memory device coupled via one or more electrical contacts, or equivalent features. Other characteristics may also be detected, and those listed herein are not to be limiting of the invention unless otherwise indicated in the claims.

In certain embodiments, only one sensor 355 may be included as part of the electronic circuitry 351, and in other embodiments, two or more sensors 355 may be included. As mentioned above, the at least one sensor 355 may be any one or more of the following: an accelerometer, a gyroscope, a magnetometer, a mechanical switch, a hall effect or variable reluctance sensor, or numerous other types of sensors. While the functionality of certain types of sensors will be discussed in greater detail below, in general each sensor 355 included as part of the electronic circuitry 351 generates a sensor signal which includes sensor data that corresponds to the characteristic detected by the sensor. For purposes of the present disclosure, the term “sensor data” is any type of information which may be extracted or derived from the sensor or sensor signal, regardless of the form of the extracted information. By way of example, sensor data may be in the form of mathematical data (such as a formula which mathematically represents at least part of the sensor signal), analog data (such as the waveform of the sensor signal), and/or digital data (such as a representation of at least part of the sensor signal in a digital format). In certain embodiments, the processor 353 and the memory 357 may be omitted from the electronic circuitry 351 of the oral care implement 1001. In such embodiments, the sensors 355 may communicate sensor data directly to the communication module for transmission.

The memory 357 may be any appropriate type of memory or storage which enables the processor 353 to perform the desired programming, such as volatile and/or non-volatile random access memory, or any other type of storage. The particular type of storage used for the memory 357 is not to be limiting of the invention. The communication module 359 in the exemplary embodiment includes an antenna 361 to enable wireless communication. The communication module 359 may be configured and/or programmed to communicate using a wireless technology standard such as Wi-Fi, Bluetooth®, and the like, or it may communicate using any type of proprietary wireless transmission protocol. In certain embodiments, the communication module 359 may include a port to enable communications using wires and wired protocols, such as USB and the like. The particular mode of communication used by the communication module is not limiting of the invention unless specifically set forth in a claim.

Referring to both FIGS. 2A and 2D, the data processing unit 405 includes a housing 463 and electronic circuitry 465, with the housing enclosing and/or supporting the various components of the electronic circuitry 465. The electronic circuitry 465 is coupled to a power source 467, shown as a battery in the exemplary embodiment. Of course, the invention is not so limited, and other types of power sources may be used. The electronic circuitry 465 includes a processor 469 communicably coupled to a memory 471, a communication module 473, and a display 475. In certain embodiments, the electronic circuitry 465 may include other components, such as a speaker to provide audible feedback to the user, one or more buttons to receive input from the user, and one or more ports for making a wired connection between the electronic circuitry 465 and other circuitry external to the data processing unit 405. In certain other embodiments, the data processing unit 405 may be a smartphone, a tablet computer, a laptop computer, and the like, although the invention is not so limiting.

The memory 471 may be any appropriate type of memory or storage which enables the processor 469 to perform the desired programming, such as volatile and/or non-volatile random access memory. The particular type of storage used for the memory 471 is not to be limiting of the invention.

The display 475 may be any type of light emitting display, and as shown in the exemplary embodiment, the display 475 may be an LED panel. In certain other embodiments, the display 475 may be an LCD panel, an OLED panel, or any other type of display which is electronically controllable by the processor 469 to provide visual feedback to the user. In certain embodiments, the display 475 may be a touch sensitive display which accepts input from the user directly on the display surface. The type and configuration of the display 475 is not limiting of the invention unless specifically set forth in a claim.

The communication module 473 includes an antenna 479 to enable wireless transmission. The communication module 473 may be configured and/or programmed to communicate using a wireless technology standard such as Wi-Fi, Bluetooth®, and the like, or it may communicate using any type of proprietary wireless transmission protocol. The mode of communication for which the communication module 473 is configured is not limiting of the invention unless specifically set forth in a claim. In certain embodiments, the communication module 473 may include a port to enable communications using wires and wired protocols, such as USB and the like. For proper functioning of the exemplary embodiment, the communication module 359 of the oral care implement 1001 and the communication module 473 of the data processing unit 405 communicate with each other, whether such communications are wireless or wired, using the same communication protocol.

The communication module 473 of the data processing unit 405 may also be configured and/or programmed to communicate with the server 407. The communication module 473 may communicate with the server 407 over any combination of public and/or private network, and the communications may be wired, wireless, or a combination of the two. In certain embodiments, the communication module 473 may communicate with the server 407 over the Internet using one or more types of communication protocols. In certain embodiments, the server 407 may be programmed with an application programming interface (API) which provides server-side functionality to the data processing unit 405.

In the exemplary embodiment, the processor 353 of the oral care implement 1001 may be programmed with functionality to analyze the sensor data generated by the sensors 355. Similarly, the processor 469 of the data processing unit 405 may be programmed with functionality to analyze the sensor data generated by the sensors 455. In the ensuing description, the disclosed processes may be partially or wholly performed by one or both of the processor 353 of the oral care implement 1001 and the processor 469 of the data processing unit 405 through programming provided to each respective processor 353, 469. In certain instances, where expressly indicated, the disclosed processes may be limited to programming on one of the processor 353 of the oral care implement 1001 or the processor 469 of the data processing unit 405.

In order to operate the oral care implement 1001, a user must couple one of the first or second heads 100, 200 to the handle 300. Each of the first and second heads 100, 200 has distinct features and physical properties that result in differing vibration response when the vibration generation device 330 is activated. Thus, the oral care implement 1001 may sense which of the first and second heads 100, 200 is coupled to the handle 300 using one or more sensors 355 as described above. In order to achieve optimal excitation of the plurality of tooth cleaning elements 152, 252 on the first or second head 100, 200, different operating parameters of the vibration generation device 330 may be utilized.

In one non-limiting example, the vibration generation device 330 may be a motor having an eccentric weight coupled to a shaft of the motor. The processor 353 may be operably coupled to the vibration generation device 330 and a voltage may be applied by the processor 353 to the vibration generation device 330. This causes the vibration generation device 330 to operate, generating vibrations which are transmitted to the head. Depending on the properties of the head 100, 200 which is presently coupled to the handle 300, the excitation of the tooth cleaning elements 152, 252 may be sub-optimal. In particular, the moment of inertia and of the head 100, 200 and the vibration transmission characteristics of the head 100, 200 both have a significant impact on the effectiveness of the tooth cleaning elements 152, 252.

By altering an operating parameter of the vibration generation device 330, it is possible to optimize the excitation of the tooth cleaning elements 152, 252. This may be done by varying an applied voltage or current, or by varying a drive frequency or drive amplitude to the vibration generation device 330. Thus, the first and second heads 100, 200 may have different resonant frequencies, moments of inertia, or other vibration transmission characteristics which require different operating parameters of the vibration generation device 330.

The sensor 355 may be used to detect which of the first or second heads 100, 200 are presently coupled to the handle 300 through a variety of means as discussed above. For example, the frequency response measured at the handle 300 may be used to calculate the moment of inertia, the resonant frequency, or other properties of the head which is currently coupled to the handle 300. This may be done by operating the vibration generation device 330 and taking measurements, then altering the operating parameters of the vibration generation device 330 and taking additional measurements. Thus, it is possible to tune the operating parameters of the vibration generation device 330 during a brushing routine or other operation cycle. It may be desired to tune the operating parameters such that maximum excitation of the tooth cleaning elements 152, 252 is achieved. In other configurations, the excitation of the tooth cleaning elements 152, 252 may be raised to a desired level that is less than a maximum excitation possible for the oral care implement 1001. The excitation may be less than maximum possible excitation to better achieve desired cleaning effectiveness, acceptable mouth-feel, or other considerations.

The sensor 355 may also operate by identifying which of the first and second heads 100, 200 is coupled and using predetermined operating parameters for the vibration generation device 330. This may be done to simplify the system while simultaneously achieving the desired excitation of the tooth cleaning elements 152, 252. In yet other implementations, the sensor 355 may be used to compute a moment of inertia or sense a characteristic indicative of inertia. This may then be used to operate the vibration generation device 330 at a predetermined set of operating parameters or may be used to perform optimization during operation of the vibration generation device 330. For instance, where the first head 100 has a greater moment of inertia than the second head 200, it may be possible to identify which head is coupled and either implement predetermined operating parameters or optimize the operating parameters to achieve superior brushing performance and excitation of the tooth cleaning elements 152, 252.

A first mode may be associated with coupling of the first head 100 while a second mode may be associated with coupling of the second head 200. The processor 353 may cause one of the operating parameters to be altered when switching from the first mode to the second mode. Otherwise stated, one of the current, voltage, amplitude, or frequency of the vibration generation device 330 may be altered during the switch from the first mode to the second mode.

In another configuration, the processor 355 may utilize information from the sensor 355 to determine which of the first or second heads 100, 200 is coupled to the handle 300. Based on which of the first or second heads 100, 200, a duration of a brushing routine may be altered. A brushing routine may be defined as a single brushing session performed by a user. Some authorities have recommended that the user perform brushing for two minutes to ensure thorough cleaning. Thus, a recommended duration of a brushing routine may be indicated to the user via a display or simply by operating the vibration generation device 330 for the recommended duration.

However, where brushing effectiveness may be increased, it is possible to reduce the recommended duration for the brushing routine. This may be achieved through improved brushing technique or via the use of a more effective head. For instance, the first head 100 may simultaneously brush 25 to 50% of a user's teeth. In contrast, the second head 200 may only be able to brush 2 to 5% of a user's teeth simultaneously. Thus, brushing effectiveness may increase for the first head 100. It would be inefficient to instruct the user to brush for two minutes with the first head 100 when the same brushing effectiveness might be achieved in only 30 seconds.

It is conceived that the processor 353 may cause the brushing routine to have a different duration when the sensor 355 generates data indicative of the first head 100 being coupled as compared to the second head 200. In other words, when the processor 353 determines that the first head 100 is coupled to the handle 300, the brushing routine may have a duration of 30 seconds. When the processor 353 determines that the second head 200 is coupled to the handle 300, the brushing routine may have a duration of two minutes. This may be performed either in combination with the change in operating parameters of the vibration generation device 330 or separately from any change in operating parameters of the vibration device 330. Otherwise stated, the duration of the brushing routine may be altered depending on the operating mode or the duration may be independently altered based on other factors.

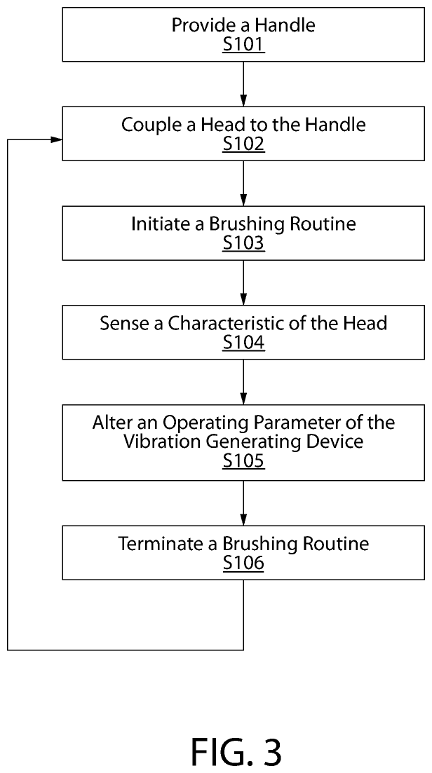

Turning to FIG. 3, a method of operating the oral care implement 1001 is described in detail. In a first step S101, a handle 300 is provided. The handle 300 has a vibration generation device 330, electronic circuitry 351, and a power source 352. The electronic circuitry 351 includes a processor 353, a memory 357, and one or more sensors 355. The processor 353 is operably coupled to the vibration generation device 330 to allow the processor 353 to control the vibration generation device 330. The processor 353 is also operably coupled to the memory 357 and the one or more sensors 355.

In a second step S102, the first or second head 100, 200 is coupled to the handle 300. In a third step S103, a brushing routine is initiated. The brushing routine results in the processor 353 controlling the vibration generation device 330 and causing the vibration generation device 330 to emit vibrations. In a fourth step S104, the sensor 355 senses a characteristic of the first or second head 100, 200.

In a fifth step S105, the processor 353 alters an operating parameter of the vibration generation device 330 based on the characteristic sensed by the sensor 355. Thus, the processor 353 may cause the vibration generation device 330 to operate at a different current, voltage, frequency, or amplitude as a result of the characteristic sensed by the sensor 355. In a sixth step, the brushing routine may be terminated. Subsequently, the process may be repeated, with another head being coupled to the handle 300, the brushing routine being initiated, a characteristic of the head being sensed, and an operating parameter of the vibration generation device 330 being altered based on the sensed characteristic of the head that is presently coupled to the handle 300. Thus, mode switching may occur automatically and without manual user intervention. Furthermore, step S104 to sense the characteristic of the head may occur before or after step S103 to initiate a brushing routine. Similarly, step S105 to alter an operating parameter of the vibration generation device 330 may also occur prior to step S103 to initiate a brushing routine.

As used throughout, ranges are used as shorthand for describing each and every value that is within the range. Any value within the range can be selected as the terminus of the range. In addition, all references cited herein are hereby incorporated by reference in their entireties. In the event of a conflict in a definition in the present disclosure and that of a cited reference, the present disclosure controls.

While the invention has been described with respect to specific examples including presently preferred modes of carrying out the invention, those skilled in the art will appreciate that there are numerous variations and permutations of the above described systems and techniques. It is to be understood that other embodiments may be utilized and structural and functional modifications may be made without departing from the scope of the present invention. Thus, the spirit and scope of the invention should be construed broadly as set forth in the appended claims.

1. An oral care implement kit comprising:
a handle comprising:
a vibration generation device;
a processor operably coupled to the vibration generation device;
a memory operably coupled to the processor; and
a sensor operably coupled to the processor;
a first head configured for detachable coupling to the handle; and
a second head configured for detachable coupling to the handle;
wherein the sensor is configured to sense which of the first and second heads is coupled to the handle.

2. The oral care implement kit of claim 1 wherein the sensor monitors a vibration response of the handle.

3. (canceled)

4. The oral care implement kit of claim 1 wherein the sensor monitors an operating parameter of the vibration generation device.

5. (canceled)

6. The oral care implement kit of claim 1 wherein the first head has a first moment of inertia and the second head has a second moment of inertia which is less than the first moment of inertia, the sensor configured to sense a characteristic indicative of inertia.

7. The oral care implement kit of claim 1 wherein the processor operates in a first mode when the sensor senses that the first head is coupled to the handle and a second mode when the sensor senses that the second head is coupled to the handle.

8. The oral care implement kit of claim 7 wherein the processor alters one of a current, an amplitude, or a frequency of the vibration generation device when switching from the first mode to the second mode.

9. The oral care implement kit of claim 1 wherein the first head has a wall and a plurality of fingers extending from the wall, a first plurality of tooth cleaning elements extending from the wall and the plurality of fingers and wherein the second head has a front surface and a second plurality of tooth cleaning elements extending from the front surface.

10. The oral care implement kit of claim 9 wherein the first head extends along an arcuate path from a first distal end to a second distal end.

11. (canceled)

12. (canceled)

13. The oral care implement kit of claim 1 wherein one of a current, an amplitude, or a frequency of the vibration generation device is altered during a brushing routine in response to input from the sensor.

14. The oral care implement kit of claim 13 wherein the processor adjusts one of the current, amplitude, or frequency of the vibration generation device to increase excitation of a plurality of tooth cleaning elements of the one of the first head or the second head that is coupled to the handle.

15. The oral care implement kit of claim 1 wherein the processor alters a duration of a brushing routine in response to input from the sensor.

16. An oral care implement comprising:
a handle comprising:
a vibration generation device;
a processor operably coupled to the vibration generation device;
a memory operably coupled to the processor; and
a sensor operably coupled to the processor;
a head configured for detachable coupling to the handle; and
wherein the sensor is configured to sense a characteristic of the head and alter an operating parameter of the vibration generation device based on the characteristic of the head.

17. The oral care implement of claim 16 wherein the sensor monitors a vibration response of the handle.

18. (canceled)

19. The oral care implement of claim 16 wherein the sensor monitors an operating parameter of the vibration generation device.

20. (canceled)

21. The oral care implement of claim 16 wherein the head has a wall and a plurality of fingers extending from the wall, a plurality of tooth cleaning elements extending from the wall and the plurality of fingers.

22. (canceled)

23. (canceled)

24. (canceled)

25. The oral care implement of claim 16 wherein one of a current, an amplitude, or a frequency of the vibration generation device is altered during a brushing routine in response to input from the sensor, wherein the processor adjusts one of the current, amplitude, or frequency of the vibration generation device to increase excitation of a plurality of tooth cleaning elements of the head.

26. (canceled)

27. The oral care implement of claim 16 wherein the processor alters a duration of a brushing routine in response to input from the sensor.

28. The oral care implement of claim 16 further comprising a second head, the sensor configured to sense which of the head or the second head is coupled to the handle, wherein the head has a first moment of inertia and the second head has a second moment of inertia which is less than the first moment of inertia.

29. (canceled)

30. The oral care implement of claim 16 wherein the characteristic is indicative of a moment of inertia of the head.

31. A method of operating an oral care implement comprising:
a) providing a handle, the handle comprising a vibration generation device, a processor operably coupled to the vibration generation device, a memory operably coupled to the processor; and a sensor operably coupled to the processor;
b) coupling a head to the handle;
c) initiating a brushing routine, the brushing routine comprising causing the vibration generation device to emit vibrations;
d) sensing, via the sensor, a characteristic of the head;
e) altering an operating parameter of the vibration generation device based on the characteristic sensed by the sensor.

32.-45. (canceled)
